(19) United States
(12) Patent Application Publication
(10) Pub. No.: US 2025/0388054 A1
(43) Pub. Date: Dec. 25, 2025

(54) Hitch Assembly

(71) Applicant: Shanghai Oceania International Co.,Ltd., Shanghai (CN)

(72) Inventor: Alexander Yebo Chen, Lake Forest, CA (US)

(21) Appl. No.: 19/098,278

(22) Filed: Apr. 2, 2025

(30) Foreign Application Priority Data
Jun. 19, 2024 (CN) 202421406527.X
Mar. 3, 2025 (CN) 202530093928.8

(51) Int. Cl. B60D 1/06; B60D 1/46

(52) U.S. Cl. CPC B60D 1/06; B60D 1/46

(57) ABSTRACT

The present disclosure aims to provide a hitch assembly comprising a towing module, connection module, and locking unit. The towing module includes a towing head for connecting to a towed object and a main body having a first engagement portion on its peripheral surface. The connection module includes a connection segment for attaching to a traction vehicle and an accommodation chamber having a second engagement portion. The main body is receivable in the accommodation chamber and movable from a first position to a second position within the accommodation chamber. In the first position, the first engagement portion engages with the second engagement portion to prevent disengagement of the towing module from the accommodation space. In the second position, the first engagement portion is disengaged from the second engagement portion to allow axial withdrawal of the towing module along its longitudinal axis. The locking unit restricts movement of the main body from the first position toward the second position. This hitch assembly demonstrates high structural strength and extended service life.

### CROSS REFERENCE TO RELATED APPLICATION

This application claims priority benefit of Chinese patent Application No. 202421406527.X, filed on Jun. 19, 2024, and No. 202530093928.8, filed on Mar. 3, 2025, and the entire contents of which are incorporated herein by reference.

### TECHNICAL FIELD

The present disclosure relates to the technical field of vehicle coupling components, in particular to hitch assembly.

### BACKGROUND

A hitch assembly, also referred to as a towing device (hitch), constitutes a critical component in vehicular towing systems. Current hitch assemblies primarily comprise two elements: a trailer ball and a drawbar. The hitch assembly is rigidly connected to the towing vehicle through the drawbar, while the towed object is hitched to the hitch assembly via the trailer ball, thereby achieving traction.

To accommodate heavier towed objects and address road conditions encountered during vehicle operation such as inclines and vibrations, structural optimization of hitch assemblies for enhanced service life and mechanical robustness remains a persistent technical challenge in this field.

### SUMMARY

The present disclosure provides a hitch assembly characterized by high structural strength and extended service life.

The hitch assembly for achieving the foregoing objectives comprises a towing module, a connection module, and a locking unit. The towing module includes at least one towing head and a main body, wherein a towed object is connected to the hitch assembly via the towing head, and the outer periphery of the main body is provided with a first engagement portion. The connection module includes a connection segment and an accommodation chamber, wherein the hitch assembly is connected to a towing vehicle via the connection segment. The accommodation chamber defines an accommodation space provided with a second engagement portion, and the main body is insertable into the accommodation space to integrally couple the towing module with the connection module. The main body within the accommodation space is movable between a first position and a second position. In the first position, the first engagement portion cooperates with the second engagement portion to prevent the towing module from disengaging from the accommodation space. In the second position, the first engagement portion is disengaged from the second engagement portion to allow the towing module to disengage from the accommodation space along its own axial direction. The locking unit is disposed in the towing module and/or the connection module, and is movable to a locked state where it restricts movement of the main body from the first position toward the second position.

In a specific embodiment, the hitch assembly comprises a towing module, a connection module, and a locking unit. The towing module includes at least one towing head and a main body, wherein a towed object is connected to the hitch assembly via the towing head. The main body includes a first connection portion and a second connection portion. The towing head is disposed on the first connection portion, while the second connection portion protrudes from one side of the first connection portion, with a first engagement portion provided on the periphery of the second connection portion. The connection module comprises a connection segment and an accommodation chamber. The hitch assembly is connected to a towing vehicle through the connection segment. The accommodation chamber defines an accommodation space containing a second engagement portion. The main body is insertable into the accommodation space to integrally connect the towing module and connection module. The main body within the accommodation space is movable between a first position and a second position. At the first position, the first engagement portion engages with the second engagement portion to prevent disengagement of the towing module from the accommodation space. At the second position, the first and second engagement portions are disengaged, allowing the towing module to disengage from the accommodation space along its axial direction. The locking unit, installed in the towing module and/or connection module, is operable to a locked state where it restricts movement of the main body from the first position toward the second position.

In a specific embodiment, the hitch assembly comprises a towing module, a connection module, and a locking unit. The towing module includes at least one towing head, a main body, and the locking unit. A towed object is connected to the hitch assembly via the towing head. The main body includes a first connection portion and a second connection portion. The first connection portion has a cubic structure with multiple mounting surfaces, at least one of which carries the towing head. The second connection portion protrudes from a mounting surface of the first connection portion, extending in a direction perpendicular to the towing head's orientation, with a first engagement portion provided on its periphery. The connection module includes a connection segment and an accommodation chamber. The hitch assembly is connected to a towing vehicle through the connection segment. The accommodation chamber defines an accommodation space containing a second engagement portion. The main body is insertable into the accommodation space to integrally connect the towing module and connection module. Within the accommodation space, the main body is movable between a first position and a second position. At the first position, the first engagement portion engages with the second engagement portion to prevent disengagement of the towing module from the accommodation space. At the second position, the first and second engagement portions disengage, allowing the towing module to disengage along its axial direction. The locking unit, installed in the towing module and/or connection module, is operable to a locked state where it restricts movement of the main body from the first position toward the second position.

The beneficial effects of this disclosure are:

In practical operating conditions, the hitch assembly with this configuration transmits towing forces through the following sequence: the towing vehicle transfers force to the connection component, which subsequently relays it to the towing component, ultimately applying the force to the towed object. When encountering specific road conditions such as vibrations, the main body section within the accommodation space exhibits a tendency for axial displacement along the towing component's central axis. During this process, positional constraint is achieved through coordinated interaction between the first engagement portion and second engagement portion. Crucially, the limiting unit exclusively restricts movement of the main body section from the first position toward the second position, without constraining its axial displacement.

The first and second engagement portions are respectively arranged on the main body section's periphery and within the accommodation space. This configuration enables structural dimension adjustments of these components according to operational demands, while preserving the towing component's inherent mechanical integrity. Consequently, this design optimization effectively extends the service life of the hitch assembly.

The foregoing description outlines the technical solution of this application. To facilitate comprehensive understanding of the implementation methods, detailed embodiments are provided in the specification. Furthermore, to render the objectives, features, and advantages of this application more explicit, specific implementation examples are enumerated below.

### BRIEF DESCRIPTION OF THE DRAWINGS

FIG. 1 is a three-dimensional schematic diagram of an embodiment of the present hitch assembly.

FIG. 2 is an exploded view of an embodiment of the hitch assembly.

FIG. 3 is a schematic diagram of a first embodiment of the retainer within the hitch assembly.

FIG. 4 is a schematic of the limiting unit assembly method for the first embodiment of the hitch assembly.

FIG. 5 is an assembly state schematic of the towing component in the first embodiment of the hitch assembly.

FIG. 6 is an exploded view of the second embodiment of the hitch assembly.

FIG. 7 outlines the limiting unit assembly method for the second embodiment of the hitch assembly.

FIG. 8 is the assembly state schematic of the towing component in the second embodiment of the hitch assembly.

FIG. 9 is an exploded view of the third embodiment of the hitch assembly.

FIG. 10 is the limiting unit assembly method for the third embodiment of the hitch assembly.

FIGS. 11 and 12 respectively illustrate the assembly state schematic of the towing component in the third embodiment of the hitch assembly from two perspectives.

FIG. 13 is a top view schematic of the retainer in the third embodiment of the hitch assembly.

FIG. 14 is a schematic diagram of a conventional towing device structure.

FIG. 15 is a three-dimensional schematic of the fourth embodiment of the hitch assembly.

FIG. 16 is an exploded view of the fourth embodiment of the hitch assembly.

FIG. 17 is a half-section view schematic of the fourth embodiment of the hitch assembly.

### DETAILED DESCRIPTION

Detailed descriptions of the embodiments under the technical solution of this application will be provided below in conjunction with the accompanying drawings. The following embodiments are presented solely to illustrate the technical solution of this application with enhanced clarity, and therefore serve exclusively as exemplary demonstrations. They shall not be construed as limiting the scope of protection of this application.

Unless otherwise defined, all technical and scientific terms used herein carry meanings identical to those routinely understood by practitioners skilled in the relevant technical field of this application. The terminology employed throughout this specification serves only to describe specific embodiments, not to restrict this application. The terms “comprise” and “have”-including all grammatical variations thereof—as used in the specification, claims, and the foregoing description of the accompanying drawings, are intended to denote non-exclusive inclusion.

As shown in the conventional towing device structure illustrated in FIG. 14, the towing device is composed of a hitch ball 901, ball retainer 902, and connecting rod 903. The ball retainer 902 is provided with a through hole 900 allowing the hitch ball 901 to pass through. The hitch ball 901 contains a fixation hole, through which fasteners 904 (e.g., bolts, pins) are installed to rigidly connect the hitch ball 901 with the ball retainer 902. In practical operation, the hitch ball 901 connects to the towed object (e.g., cargo), while the connecting rod 903 attaches to the traction vehicle (e.g., automobile), thereby enabling towing functionality. However, in the conventional configuration depicted in FIG. 14, the fasteners 904 serve to axially constrain the hitch ball 901 within the through hole 900. Although the hitch ball 901 primarily experiences radial tensile forces along the towing direction during normal operation, significant axial forces may act on the fasteners 904 under special road conditions such as bumpy surfaces. If the fasteners 904 have insufficient diameter, failures like fracturing may occur. Conversely, over-dimensioned fasteners would necessitate excessively large fixation holes in the hitch ball 901, thereby compromising the structural integrity of the hitch ball itself. These issues collectively reduce the service life of the towing device.

To address deficiencies in conventional towing device structures, embodiments according to this application provide a hitch assembly featuring rational structural design, characterized by high structural strength and extended service life.

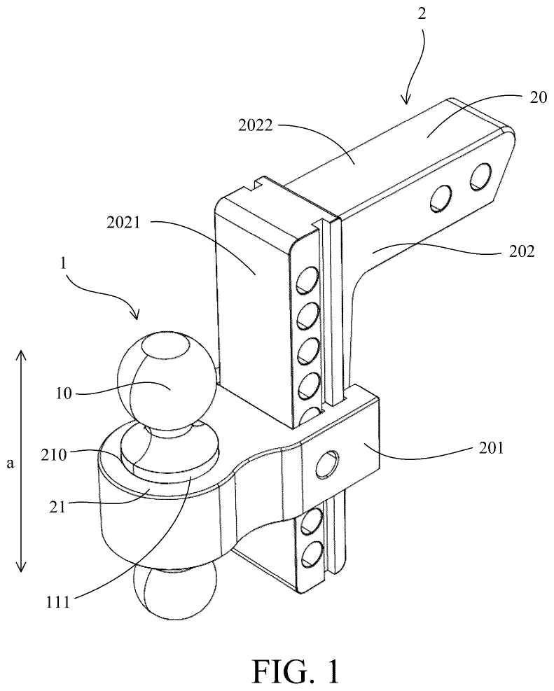

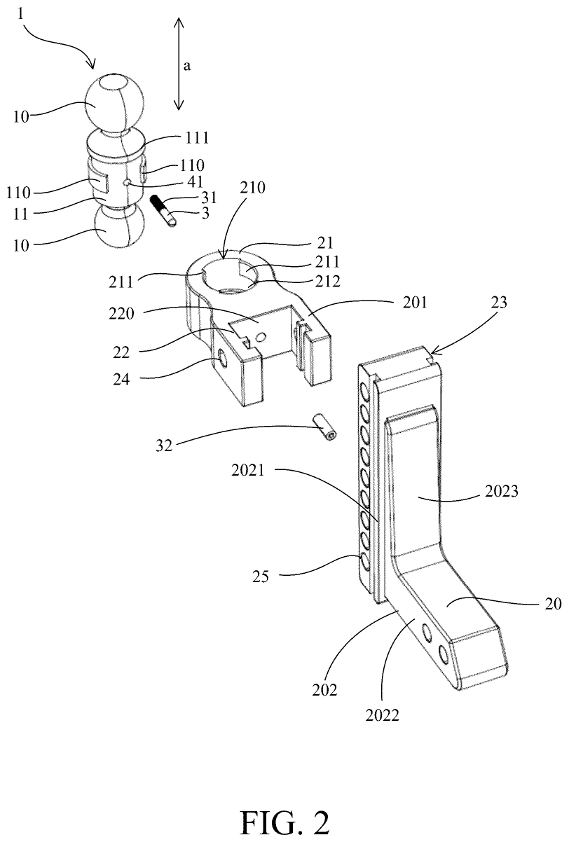

FIG. 1 shows a perspective view of an embodiment of the hitch assembly, while FIG. 2 illustrates an exploded view of another embodiment. The hitch assembly comprises a towing module 1, connection module 2, and locking unit 3. The towing module 1 includes at least one towing head 10 and a main body 11. The towing head 10 interfaces with towed objects (e.g., cargo), and the main body 11 is provided with a first engagement portion 110 on its peripheral surface. The connection module 2 consists of a connection segment 20 and an accommodation chamber 21. The connection segment 20 attaches to traction vehicles (e.g., automobiles), while the accommodation chamber 21 defines an accommodation space 210 containing a second engagement portion 211. The main body 11 is insertable into the accommodation space 210 to integrally couple the towing module 1 with the connection module 2.

The main body 11 located in the accommodation space 210 is movable between a second position and a first position. In the first position, the first engagement portion 110 engages with the second engagement portion 211 to restrict disengagement of the towing module 1 from the accommodation space 210. In the second position, the first engagement portion 110 is disengaged from the second engagement portion 211 to permit axial withdrawal of the towing module 1 along its longitudinal axis direction a from the accommodation space 210. The locking unit 3 is disposed in the towing module 1 and/or the connection module 2, and is movable to a locked state. When in the locked state, the locking unit 3 restricts movement of the main body 11 located in the first position toward the second position.

In practical operating conditions of the hitch assembly with this configuration, the towing vehicle transmits tensile forces to the connection module 2, which subsequently transfers the forces to the towing module 1, ultimately applying them to the towed object. When encountering special road conditions such as bumps, the main body 11 located within the accommodation space 210 tends to exhibit axial displacement along the longitudinal axis a of the towing module 1. At this stage, the first engagement portion 110 and the second engagement portion 211 cooperatively achieve positional confinement. The locking unit 3 only functions to restrict the movement of the main body 11 from the first position toward the second position, without limiting the axial displacement of the main body 11 along the longitudinal axis a. The first engagement portion 110 and the second engagement portion 211 are respectively disposed on the periphery of the main body 11 and within the accommodation space 210. This configuration allows adjustment of their structural dimensions according to actual operating requirements without compromising the inherent structural strength of the towing module 1, thereby effectively extending the service life of the hitch assembly.

In the description of embodiments herein, technical terms such as “first XX” and “second XX” (e.g., “first engagement portion” and “second engagement portion”) are used solely to distinguish between different entities. These designations should not be construed as indicating relative importance, implicitly specifying the quantity of technical features, or implying any particular sequence or hierarchical relationship.

The term “and/or” in the context of this application describes an associative relationship between related elements, specifically denoting three possible scenarios. For instance, “A and/or B” may represent: 1) Existence of A alone; 2) Coexistence of A and B; 3) Existence of B alone.

References to “embodiments” in this document indicate that particular features, structures, or characteristics described in connection with the embodiments may be incorporated in at least one embodiment of the present application. The appearance of this phrase in multiple sections of the specification does not necessarily refer to identical embodiments, nor are these embodiments mutually exclusive or alternative to other embodiments. Those skilled in the art will explicitly and implicitly understand that the described embodiments may be combined with other embodiments.

In certain embodiments of the hitch assembly, the accommodation space 210 is configured as a through-hole as illustrated, into which the main body 11 can be inserted. The main body 11 within the through-hole is capable of rotating from the first position to the second position, and conversely from the second position to the first position. By designing the accommodation space 210 as a through-hole, the assembly process requires merely inserting the main body 11, thereby significantly improving assembly efficiency.

In other embodiments differing from the illustrated configuration, the accommodation space may alternatively be a blind hole or an appropriately shaped groove. In such cases, the main body may translate from the second position to the first position within an elongated groove-shaped accommodation space.

In certain embodiments of the hitch assembly, the main body 11 is configured with a cylindrical shape as illustrated. The first engagement portion 110 is defined as a first protrusion disposed on the peripheral surface of the main body 11, while the second engagement portion 211 is a second protrusion formed within the accommodation space 210. The quantities of both the first and second protrusions are at least one each. In the illustrated embodiment, the second protrusions are arranged as a pair, with the first protrusions correspondingly configured as a pair to match the quantity of the second protrusions. A clearance notch 212 is formed between the paired second protrusions. During insertion of the main body 11 into the accommodation space 210 along the opening direction of the through-hole, the clearance notch 212 accommodates the first protrusion, enabling the main body 11 to reach the second position. Subsequent rotation of the main body 11 aligns the first and second protrusions along the opening direction of the through-hole, thereby preventing disengagement of the main body 11 from the accommodation space 210 through their interlocking engagement. This structural configuration utilizes the interaction between the first and second protrusions to restrict unintended disassembly. By increasing the thickness of the first protrusion and/or second protrusion, the axial strength of the hitch assembly can be enhanced while maintaining structural simplicity and assembly convenience.

In other embodiments differing from the illustrated configuration, the quantity of the first protrusion and/or second protrusion may differ from the depicted arrangement, potentially comprising one or multiple protrusions. For instance, the first protrusion may be configured with a semi-arcuate configuration, while the second protrusion is correspondingly configured with a matching semi-arcuate profile. In further alternative embodiments distinct from the illustrated example, the first engagement portion 110 may alternatively be implemented as a groove formed on the peripheral surface of the main body 11, with the second engagement portion 211 correspondingly configured as a protruding block adapted to engage said groove.

In certain embodiments of the present hitch assembly, the main body 11 is provided with a third protrusion 111 at one end. When the main body 11 is advanced along axis direction a of the towing module into the accommodation space 210 until the third protrusion 111 abuts against the connection module 2, the first engagement portion 110 becomes offset from the second engagement portion 211 along axis direction a of the towing module (i.e., the first engagement portion 110 is positioned below the second engagement portion 211 in the orientation shown in FIGS. 1 and 2). This configuration allows the main body 11 to transition from the second position to the first position. In specific embodiments of the hitch assembly as illustrated, the third protrusion 111 is configured as an annular rib circumferentially disposed on the outer periphery of the main body 11. In alternative embodiments, the third protrusion 111 may adopt other suitable geometries, such as a boss. The incorporation of the third protrusion 111 facilitates alignment between the towing module 1 and the connection module 2 during assembly, thereby streamlining the installation process.

In specific embodiments of the present hitch assembly, the towing head 10 is configured as a spherical head. As illustrated, the towing head 10 may comprise a pair of spherical heads disposed at both ends of the main body 11. It will be appreciated that in alternative embodiments differing from the illustrated configuration, the spherical head may exist as a single unit. In other viable embodiments, the towing head 10 may adopt alternative geometries such as a square head or disk-shaped configuration.

In particular embodiments of the hitch assembly, the connection module 2 includes a retainer frame 201 and a linkage frame 202. The retainer frame 201 defines an accommodation chamber 21, while the linkage frame 202 comprises a longitudinal rod 2021 and a transverse rod 2022 that collectively form a connection section 20. The retainer frame 201 is slidably engaged with the longitudinal rod 2021. The connection module 2 further includes a locking pin (not shown) configured to secure the retainer frame 201 to the longitudinal rod 2021. A reinforcing rib 2023 is disposed between the longitudinal rod 2021 and transverse rod 2022 to enhance the structural integrity of the linkage frame 202. Specifically, the retainer frame 201 incorporates a sliding channel 22, and the longitudinal rod 2021 is provided with a guide rail 23. The engagement between the guide rail 23 and sliding channel 22 enables sliding motion of the retainer frame 201 along the longitudinal rod 2021. The retainer frame 201 is further provided with a first fixing bore 24 on its periphery, while the longitudinal rod 2021 features a second fixing bore 25. When the retainer frame 201 slides to align the first fixing bore 24 with the second fixing bore 25, insertion of a locking pin (e.g., shear pin) achieves fixation of the retainer frame 201 to the longitudinal rod 2021. Notably, alternative embodiments may integrate the retainer frame 201 and linkage frame 202 as an integrated component, whereas the present separable configuration allows adjustable height customization of the spherical head.

Building upon the preceding embodiments, the following first to third embodiments detail specific configurations of the locking unit 3 for restricting movement of the main body 11 within the accommodation space 210 from the first position toward the second position:

### First Embodiment

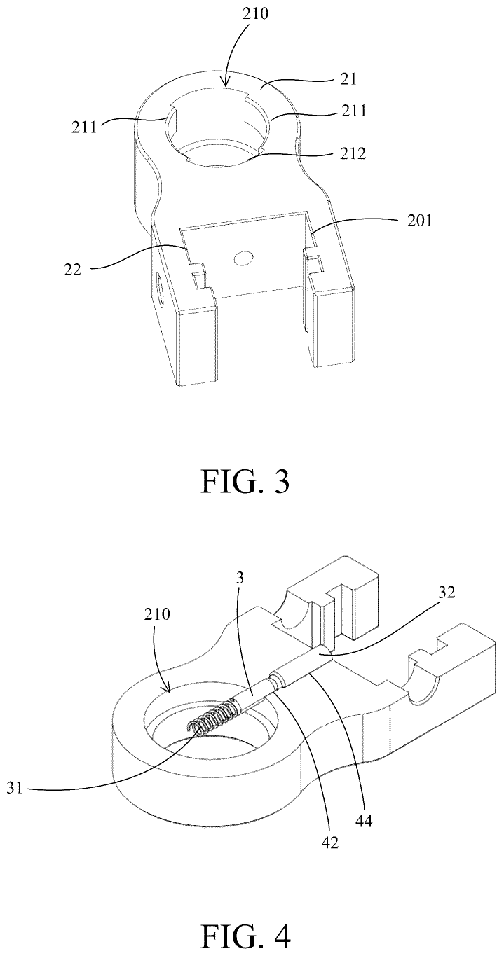

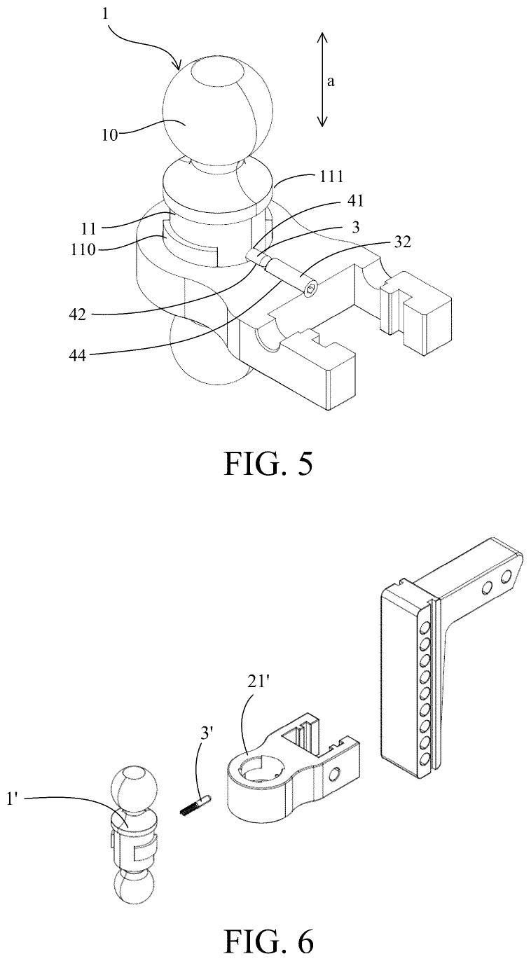

FIGS. 2-5 illustrate schematic diagrams of the first embodiment of the present hitch assembly, wherein: FIG. 3 shows a schematic diagram of the first embodiment of the retainer frame in the hitch assembly; FIG. 4 illustrates an assembly method of the locking unit in the first embodiment of the hitch assembly, with the retainer frame shown in a semi-sectional structure in FIG. 4; FIG. 5 depicts an assembled state of the towing module in the first embodiment of the hitch assembly, with the retainer frame shown in a semi-sectional structure in FIG. 5.

In this first embodiment, the main body 11 is formed with a first bore 41, and the accommodation chamber 21 is formed with a second bore 42 communicating with the accommodation space 210. The locking unit 3 is disposed in one of the first bore 41 and the second bore 42. After the main body 11 moves from the second position to the first position (i.e., the state shown in FIG. 5), the first bore 41 aligns with the second bore 42, such that the locking unit 3 can be partially inserted into the other of the first bore 41 and the second bore 42 under external force to restrict movement of the main body 11.

Specifically, as shown in the figures, the first bore 41 is provided with a biasing element 31. The locking unit 3 is a locking pin elastically supported in the first bore 41. The biasing element 31 is configured to fully retract the locking pin into the first bore when compressed and partially protrude the locking pin out of the first bore 41 when uncompressed. During assembly of the hitch assembly with this configuration: Firstly, the locking unit 3 is initially compressed into the first bore 41. Secondly, the main body 11 is placed into the accommodation space 210. Then, external force is applied to move the main body 11 from the second position toward the first position. During this movement, the locking unit 3 abuts against the wall defining the accommodation space 210 to maintain its compressed state within the first bore 41. Upon alignment of the first bore 41 and the second bore 42, the biasing element 31 extends the locking unit 3 such that:
at least a portion of the locking unit 3 remains in the first bore 41;
the remaining portion extends into the second bore 42 to achieve positional locking.

In a specific embodiment, the locking unit 3 is a helical spring.

In some alternative embodiments differing from the illustrated configuration, the locking unit 3 may be disposed in the second bore, such as a first magnetic assembly. A second magnetic assembly is provided in the first bore of the main body. When the first bore aligns with the second bore, the second magnetic assembly magnetically extracts the first magnetic assembly to achieve positional locking.

In the aforementioned first embodiment, the accommodation chamber 21 is formed with a fourth bore 44 coaxial with the second bore 42. The fourth bore 44 communicates at one end with the second bore 42 and at the other end with the external space of the accommodation chamber 21. The inner diameter of the fourth bore 44 is greater than or equal to that of the second bore 42. The hitch assembly further includes a plug 32 removably connected to the fourth bore 44, such as via threaded connection. To disassemble the towing module 1, remove the plug 32 first, then eject the locking unit 3 and biasing element 31 from the second bore 42 and fourth bore 44, and finally move the main body to the second position for removal.

The first embodiment may include variations. For example, with the fourth bore 44 having an inner diameter greater than or equal to the second bore 42, an ejector unit (e.g., a taper-headed bolt) is disposed in the fourth bore. To disassemble the towing module 1, rotate the bolt to press the locking unit 3 with its taper head, forcing retraction into the second bore, then move the main body to the second position for removal.

This configuration facilitates manufacturing, as the fourth bore 44 in the external space of the accommodation chamber 21 has an inner diameter matching or exceeding that of the second bore 42.

### Second Embodiment

FIGS. 6-8 illustrate schematic diagrams of the second embodiment of the present hitch assembly, wherein FIG. 6 shows an exploded view of the second embodiment of the hitch assembly;

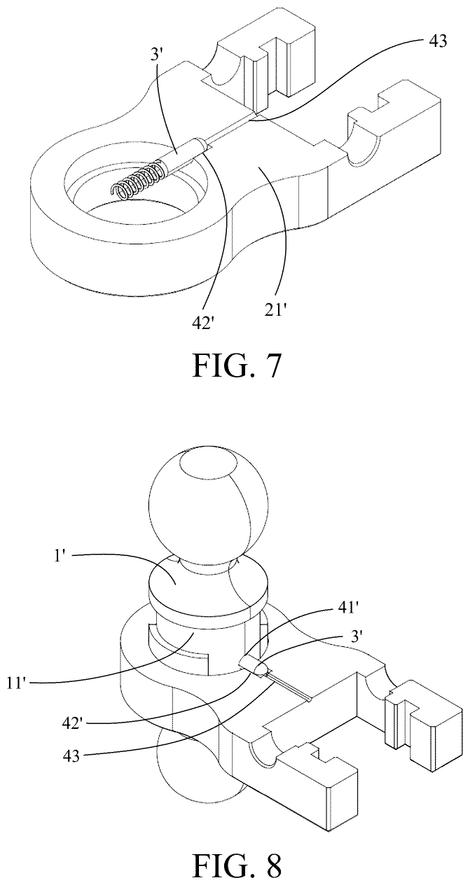

FIG. 7 illustrates an assembly method of the locking unit in the second embodiment of the hitch assembly, with the retainer frame shown in a semi-sectional structure in FIG. 7; FIG. 8 depicts an assembled state of the towing module in the second embodiment of the hitch assembly, with the retainer frame shown in a semi-sectional structure in FIG. 8.

Based on the first embodiment, the second embodiment differs as follows: the accommodation chamber 21′ is formed with a third bore 43 coaxial with the second bore 42′. The third bore 43 communicates at one end with the second bore 42′ and at the other end with the external space of the accommodation chamber 21′, wherein the inner diameter of the third bore 43 is smaller than that of the second bore 42′. To disassemble the towing module 1′, a component such as a drift pin is inserted through the fourth bore 44 to press the locking unit 3′, forcing its retraction into the second bore 42′. The main body 11′ is then moved to the second position for removal.

### Third Embodiment

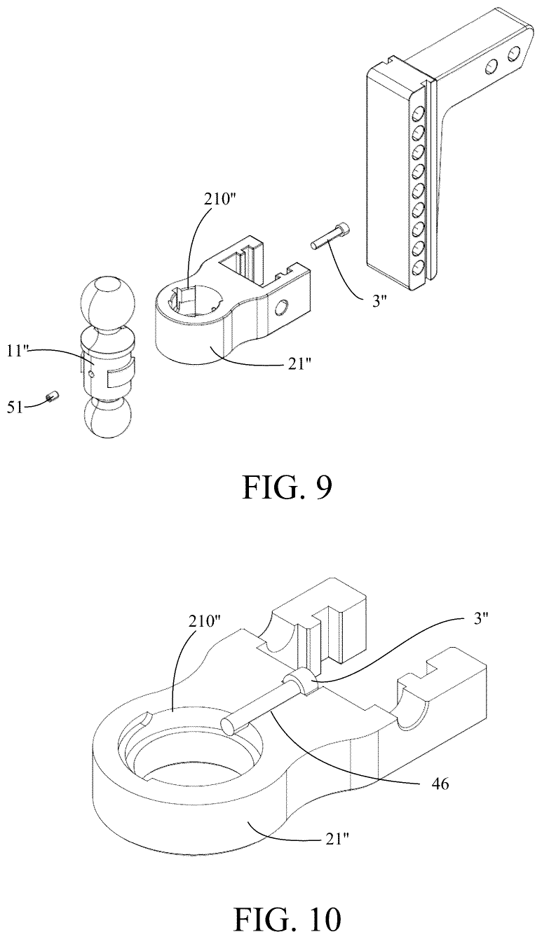

FIGS. 9-13 illustrate schematic diagrams of the third embodiment of the present hitch assembly, wherein FIG. 9 shows an exploded view of the third embodiment of the hitch assembly;

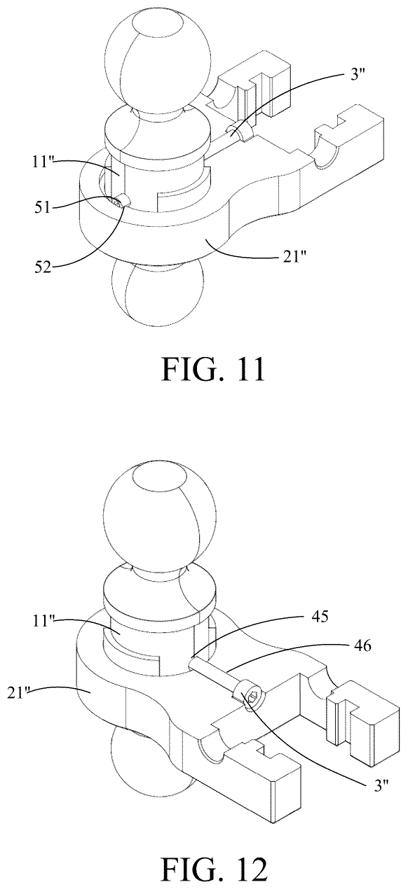

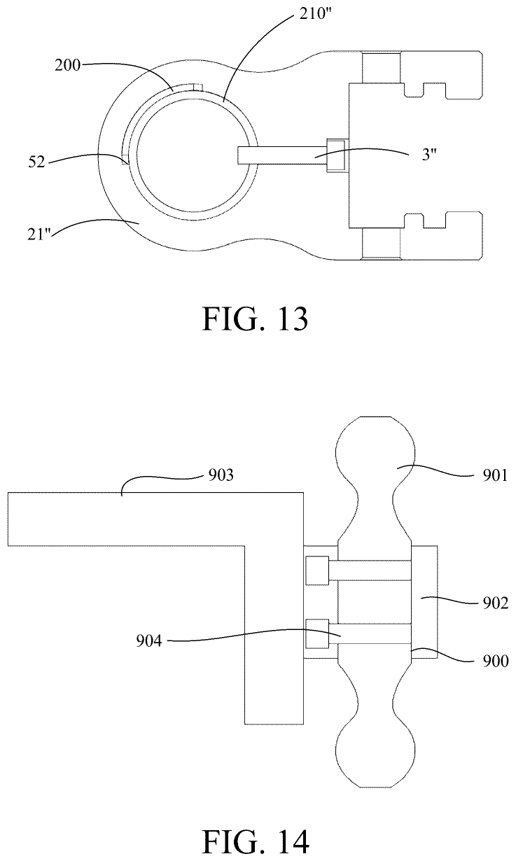

FIG. 10 depicts an assembly method of the locking unit in the third embodiment of the hitch assembly, with the retainer frame shown in a semi-sectional structure in FIG. 10; FIGS. 11 and 12 respectively show assembled states of the towing module in the third embodiment of the hitch assembly from two perspectives, with the retainer frame shown in a semi-sectional structure in both FIGS. 11 and 12; FIG. 13 provides a top-view schematic of the retainer frame in the third embodiment of the hitch assembly.

In this embodiment, the main body 11″ is formed with a fifth bore 45, while the accommodation chamber 21″ is formed with a sixth bore 46 connecting the accommodation space 210″ to the external space of the accommodation chamber 21″. The main body 11″ further includes a third engagement portion 51, and the accommodation space 210″ correspondingly has a fourth engagement portion 52. When the main body 11″ within the accommodation space 210″ moves from the second position toward the first position, the third engagement portion 51 advances toward the fourth engagement portion 52 until reaching the first position, where contact between the third and fourth engagement portions restricts further movement of the main body 11″. The fifth bore 45 aligns with the sixth bore 46 at the first position, allowing the locking unit 3″ to be externally inserted through both bores to immobilize the main body 11″ within the accommodation space 210″.

In a specific implementation, the main body 11″ further includes a seventh bore 47 opposite the fifth bore 45. The third engagement portion 51 is a pin shaft disposed within the seventh bore 47, while the accommodation space 210″ is formed with a quarter-annular groove 200 whose side wall constitutes the fourth engagement portion 52. When the pin shaft rotates to abut the side wall of the quarter-annular groove 200, the main body 11″ precisely reaches the first position. This configuration facilitates rapid verification of proper positioning of the main body 11″.

In alternative embodiments differing from the illustrated configuration, the third engagement portion may be a groove, while the fourth engagement portion is a protrusion.

In the aforementioned first to third embodiments, the hitch assembly may further include the following feature: the second bore 42 or sixth bore 46 is oriented in the same direction as the tensile force acting on the hitch assembly under actual working conditions, with the locking unit 3 configured as a pin shaft. In conventional configurations such as that shown in FIG. 14, when the fastener 904 is a bolt, the tensile load on the spherical head 901 is shared between the fastener 904 and the spherical head 901, leading to accelerated wear of the fastener 904. By aligning the second bore 42 or sixth bore 46 with the tensile force direction and configuring the locking unit 3 as a pin shaft, the locking unit 3 solely prevents rotation of the main body 11 without bearing actual tensile loads. The tensile force is instead transmitted through the main body 11 and the curved wall surfaces of the accommodation chamber 21, thereby significantly enhancing the service life of the hitch assembly.

Specifically, in the illustrated embodiment, the second bore 42 or sixth bore 46 is formed in the bottom wall 220 of the sliding channel 22 of the retainer frame 201. In alternative embodiments, the second bore 42 or sixth bore 46 may alternatively be formed in the curved wall surfaces of the retainer frame 201. Positioning the second bore 42 or sixth bore 46 within the bottom wall 220 of the sliding channel 22 enables concealment of the locking components, providing anti-theft functionality.

### Forth Embodiment

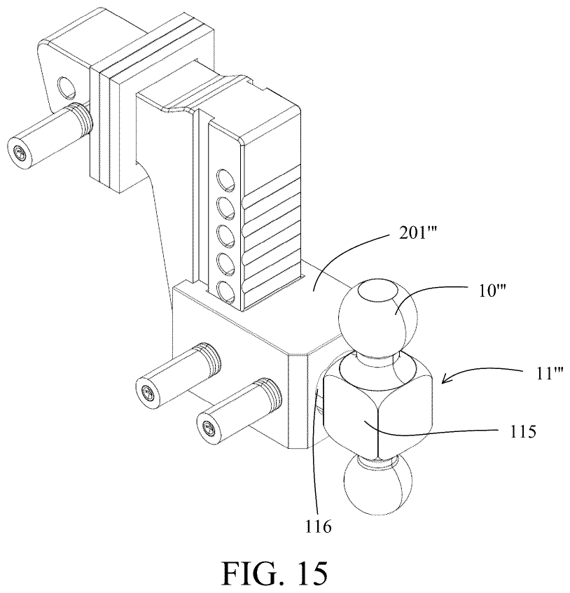

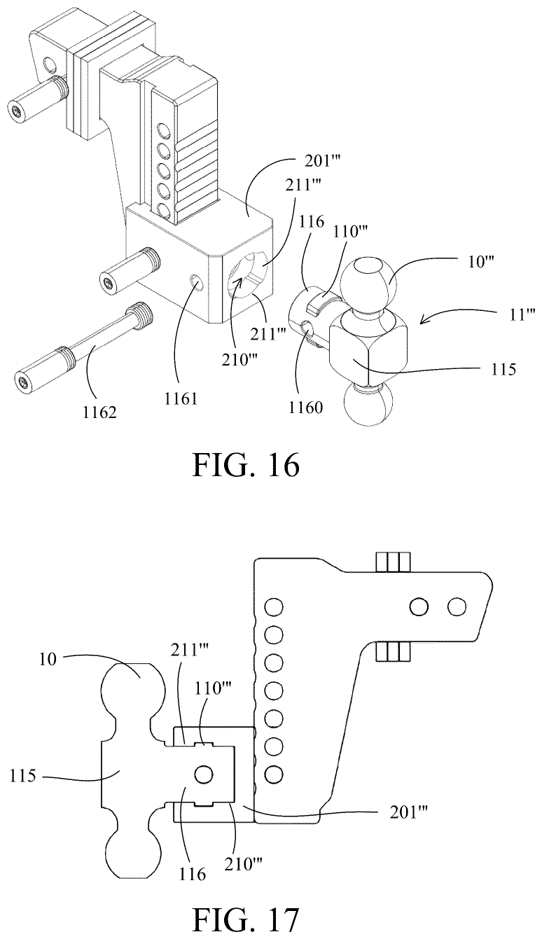

FIGS. 15-17 illustrate schematic diagrams of the fourth embodiment of the present hitch assembly, wherein FIG. 15 shows a perspective view of the fourth embodiment; FIG. 16 provides an exploded view of the fourth embodiment; FIG. 17 depicts a semi-sectional view of the fourth embodiment.

In this fourth embodiment, the main body 11″ comprises a longitudinal connection portion 115 and a transverse connection portion 116. The towing head 10″ is disposed on the longitudinal connection portion 115, while the transverse connection portion 116 protrudes laterally from the longitudinal connection portion 115. The first engagement portion 110″ is positioned on the outer periphery of the transverse connection portion 116. In the connected state shown in FIG. 15, the transverse connection portion 116 is inserted into the accommodation space 210″ formed within the retainer frame 201″. Specifically, as shown in FIGS. 15-17, the accommodation space 210′ is a bore in the retainer frame 201″ with a boss-shaped second engagement portion 211″ at its entrance. Clearance notches 212′ are formed between adjacent boss-shaped second engagement portions 211″. During assembly, the transverse connection portion 116 is inserted along the axial direction of the bore-shaped accommodation space 210″, with the clearance notches 212′″ accommodating the first engagement portion 110″ to allow movement of the transverse connection portion 116 and main body 11″ to the second position. By rotating the main body 11″, the first engagement portion 110″ aligns with the second engagement portion 211″ along the bore axis, thereby preventing disengagement of the transverse connection portion 116 and main body 11″ from the accommodation space 210″. Unlike the first to third embodiments, this disengagement direction coincides with the actual towing force direction, enabling force transmission through the engagement between the first and second engagement portions. Increased thickness and height of the first engagement portion 110′″ and second engagement portion 211″ enhance the towing capacity of this configuration.

Furthermore, the transverse connection portion 116 in this fourth embodiment includes a first connection bore 1160, while the connection module contains a second connection bore 1161. In the connected state, these bores align to form a passage for receiving the locking unit—specifically, the pin shaft 1162 as illustrated—to achieve a locked configuration.

In specific implementations, the towing head 10′ may be a spherical head. While the illustrated embodiment shows a pair of towing heads 10′ on the longitudinal connection portion 115, alternative embodiments may incorporate one, three, four, or multiple heads. The fourth embodiment's configuration allows greater flexibility in quantity and positioning of spherical heads compared to the first three embodiments.

As shown, the longitudinal connection portion 115 may have a cubic structure with multiple mounting surfaces. At least one mounting surface carries the towing head 10′″—for instance, opposing surfaces in the illustrated example each bear a towing head 10″. The transverse connection portion 116 extends perpendicularly from these mounting surfaces, orthogonal to the orientation of the towing heads 10″.

In a specific embodiment, the hitch assembly comprises a towing module, a connection module, and a locking unit. The towing module includes at least one towing head and a main body, wherein a towed object is connected to the hitch assembly via the towing head. The main body includes a first connection portion and a second connection portion. The towing head is disposed on the first connection portion, while the second connection portion protrudes from one side of the first connection portion, with a first engagement portion provided on the periphery of the second connection portion. The connection module comprises a connection segment and an accommodation chamber. The hitch assembly is connected to a towing vehicle through the connection segment. The accommodation chamber defines an accommodation space containing a second engagement portion. The main body is insertable into the accommodation space to integrally connect the towing module and connection module. The main body within the accommodation space is movable between a first position and a second position. At the first position, the first engagement portion engages with the second engagement portion to prevent disengagement of the towing module from the accommodation space. At the second position, the first and second engagement portions are disengaged, allowing the towing module to disengage from the accommodation space along its axial direction. The locking unit, installed in the towing module and/or connection module, is operable to a locked state where it restricts movement of the main body from the first position toward the second position.

In a specific embodiment, the hitch assembly comprises a towing module, a connection module, and a locking unit. The towing module includes at least one towing head, a main body, and the locking unit. A towed object is connected to the hitch assembly via the towing head. The main body includes a first connection portion and a second connection portion. The first connection portion has a cubic structure with multiple mounting surfaces, at least one of which carries the towing head. The second connection portion protrudes from a mounting surface of the first connection portion, extending in a direction perpendicular to the towing head's orientation, with a first engagement portion provided on its periphery. The connection module includes a connection segment and an accommodation chamber. The hitch assembly is connected to a towing vehicle through the connection segment. The accommodation chamber defines an accommodation space containing a second engagement portion. The main body is insertable into the accommodation space to integrally connect the towing module and connection module. Within the accommodation space, the main body is movable between a first position and a second position. At the first position, the first engagement portion engages with the second engagement portion to prevent disengagement of the towing module from the accommodation space. At the second position, the first and second engagement portions disengage, allowing the towing module to disengage along its axial direction. The locking unit, installed in the towing module and/or connection module, is operable to a locked state where it restricts movement of the main body from the first position toward the second position.

In the description of embodiments of the present application, “Bore A and Bore B being coaxial” means that Bore A and Bore B are formed along substantially identical axial directions. For example, they may share the same axial direction, or the axial direction of one bore may have a component along the axial direction of the other bore. Preferably, the deviation angle from said direction is within 10°, and more preferably within 5°.

In the description of embodiments herein, technical terms such as “mounting,” “interconnecting,” “connecting,” and “fixing” shall be interpreted broadly unless explicitly defined or limited. For example, connections may be fixed, detachable, or integral; they may be direct or mediated through intermediate components, and may refer to internal communication between two elements or their interactive relationships. Those skilled in the art will understand the specific meanings of these terms in the context of the embodiments based on practical circumstances.

It should be understood that “along” a specified direction as used herein indicates at least a component in that direction, preferably with a deviation angle within 10°, and more preferably within 5°.

Finally, it is noted that the above embodiments are provided solely to illustrate the technical solutions of this application and do not limit its scope. Although the application has been described in detail with reference to the foregoing embodiments, those skilled in the art will understand that modifications to the technical solutions described in these embodiments, or equivalent substitutions of some or all technical features, may still be made. Such modifications or substitutions shall not depart from the essence of the technical solutions covered by the embodiments of this application and shall fall within the scope of the claims and specification. Notably, all technical features mentioned in the embodiments may be combined in any manner unless structural conflicts arise. This application is not limited to the specific embodiments disclosed herein but encompasses all technical solutions falling within the scope of the claims.

What is claimed is:

1. A hitch assembly, characterized by comprising:
a towing module including:
at least one towing head through which a towed object is connected to the hitch assembly; and
a main body whose outer periphery is provided with a first engagement portion;
a connection module including:
a connection segment through which the hitch assembly is connected to a towing vehicle; and
an accommodation chamber defining an accommodation space provided with a second engagement portion, the main body being insertable into the accommodation space to integrally couple the towing module with the connection module; and
a locking unit;
wherein the main body within the accommodation space is movable between a first position and a second position; in the first position, the first engagement portion cooperates with the second engagement portion to prevent the towing module from disengaging from the accommodation space; in the second position, the first engagement portion is disengaged from the second engagement portion to allow the towing module to disengage from the accommodation space along its own axial direction;
the locking unit is disposed in the towing module and/or the connection module, and is movable to a locked state where it restricts movement of the main body from the first position toward the second position.

2. The hitch assembly according to claim 1, characterized in that:
the accommodation space is defined by a through bore, and the main body located within the through bore is rotatably movable between the first position and the second position.

3. The hitch assembly according to claim 1, characterized in that:
the main body is cylindrical-shaped, and the main body includes a cylinder having a longitudinal direction, the first engagement portion is a first protrusion disposed on the outer periphery of the main body, the second engagement portion is a second protrusion disposed in the accommodation space, and the first protrusion and the second protrusion are each provided in at least one quantity.

4. The hitch assembly according to claim 3, characterized in that:
the towing head is disposed at one end in the longitudinal direction of the cylinder.

5. The hitch assembly according to claim 3, characterized in that:
the towing head is a pair disposed at both ends in the longitudinal direction of the cylinder.

6. The hitch assembly according to claim 1, characterized in that:
a third protrusion is disposed at one end of the main body; when the main body is inserted into the accommodation space along the longitudinal axial direction of the towing module until the third protrusion abuts against the connection module, the first engagement portion is offset from the second engagement portion in the longitudinal axial direction of the towing module, thereby allowing the main body to move from the second position to the first position.

7. The hitch assembly according to claim 1, characterized in that:
the main body is formed with a first bore, the accommodation chamber is formed with a second bore communicating with the accommodation space, and the locking unit is accommodated in one of the first bore and the second bore;
when the main body moves from the second position to the first position, the first bore and the second bore are aligned with each other such that the locking unit can be partially inserted into the other of the first bore and the second bore under an external force to restrict movement of the main body.

8. The hitch assembly according to claim 7, characterized in that:
a biasing element is disposed in the first bore, the locking unit is a locking pin elastically supported in the first bore, and the biasing element is configured to: cause the locking pin to be fully retracted into the first bore when compressed, and cause a portion of the locking pin to partially protrude out of the first bore when uncompressed.

9. The hitch assembly according to claim 8, characterized in that:
the accommodation chamber is formed with a third bore coaxially arranged with the second bore, one end of the third bore communicating with the second bore and the other end communicating with an external space of the accommodation chamber;
wherein an inner diameter of the third bore is smaller than an inner diameter of the second bore.

10. The hitch assembly according to claim 8, characterized in that:
the accommodation chamber is formed with a fourth bore coaxially arranged with the second bore, one end of the fourth bore communicating with the second bore and the other end communicating with an external space of the accommodation chamber;
wherein an inner diameter of the fourth bore is greater than or equal to an inner diameter of the second bore, and the hitch assembly further comprises a plug or an ejector unit detachably connected in the fourth bore.

11. The hitch assembly according to claim 1, characterized in that:
the main body is formed with a fifth bore, the accommodation chamber is formed with a sixth bore communicating the accommodation space with an external space of the accommodation chamber, and the main body is further provided with a third engagement portion while the accommodation space correspondingly comprises a fourth engagement portion;
wherein when the main body located in the accommodation space moves from the second position toward the first position, the third engagement portion moves toward the fourth engagement portion until reaching the first position, where the third engagement portion contacts the fourth engagement portion to restrict further movement of the main body;
the fifth bore and the sixth bore are aligned at the first position, and a locking unit is insertable from outside into the fifth bore and the sixth bore to restrict movement of the main body within the accommodation space.

12. The hitch assembly according to claim 7, characterized in that the orientation of the second bore is identical to the direction of the tensile force applied to the hitch assembly under actual operating conditions, and the locking unit is the pin shaft.

13. The hitch assembly according to claim 11, characterized in that the orientation of the sixth bore is identical to the direction of the tensile force applied to the hitch assembly under actual operating conditions, and the locking unit is a pin shaft.

14. The hitch assembly according to claim 1, characterized in that the main body comprises a longitudinal connection portion and a transverse connection portion, the towing head is disposed on the longitudinal connection portion, and the transverse connection portion protrudes from one side of the longitudinal connection portion;
wherein the first engagement portion is disposed on an outer periphery of the transverse connection portion, and in a connected state, the transverse connection portion is inserted into the accommodation space.

15. The hitch assembly according to claim 14, characterized in that the transverse connection portion is provided with a first connection bore, the connection module is provided with a second connection bore, and in the connected state, the first connection bore and the second connection bore are aligned to form a passage that allows the locking unit to be inserted therethrough to move to the locked state.

16. The hitch assembly according to claim 14, characterized in that the towing head is a single one disposed on the longitudinal connection portion.

17. The hitch assembly according to claim 14, characterized in that the towing head is a pair disposed on the longitudinal connection portion.

18. The hitch assembly according to claim 14, characterized in that the towing head is three or four disposed on the longitudinal connection portion.

19. A hitch assembly, characterized by comprising:
a towing module comprising:
at least one towing head through which a towed object is connected to the hitch assembly; and
a main body including a first connection portion and a second connection portion, the first connection portion being provided with the towing head, the second connection portion protruding from a side of the first connection portion, the second connection portion having a first engagement portion on its outer periphery;
a connection module comprising:
a connection segment through which the hitch assembly is connected to a towing vehicle; and
an accommodation chamber having an accommodation space provided with a second engagement portion, the main body being insertable into the accommodation space to integrally connect the towing module with the connection module; and
a locking unit;
wherein the main body located in the accommodation space is movable between a first position and a second position, the first engagement portion and the second engagement portion engage with each other in the first position to restrict the towing module from disengaging from the accommodation space, and the first engagement portion and the second engagement portion are disengaged from each other in the second position to allow the towing module to disengage from the accommodation space along its own axial direction;
the locking unit is disposed in the towing module and/or the connection module and is movable to a locked state, the locking unit in the locked state restricting movement of the main body in the first position toward the second position.

20. A hitch assembly, characterized by comprising:
a towing module comprising:
at least one towing head through which a towed object is connected to the hitch assembly; and
a main body including a first connection portion and a second connection portion, the first connection portion being cuboid-shaped and having multiple mounting surfaces, the towing head being disposed on at least one of the mounting surfaces, the second connection portion protruding from the mounting surface of the first connection portion with an extension direction perpendicular to that of the towing head, the second connection portion having a first engagement portion on its outer periphery;
a connection module comprising:
a connection segment through which the hitch assembly is connected to a towing vehicle; and
an accommodation chamber having an accommodation space provided with a second engagement portion, the main body being insertable into the accommodation space to integrally connect the towing module with the connection module; and
a locking unit;
wherein the main body located in the accommodation space is movable between a first position and a second position, the first engagement portion and the second engagement portion engage with each other in the first position to restrict the towing module from disengaging from the accommodation space, and the first engagement portion and the second engagement portion are disengaged from each other in the second position to allow the towing module to disengage from the accommodation space along its own axial direction;
the locking unit is disposed in the towing module and/or the connection module and is movable to a locked state, the locking unit in the locked state restricting movement of the main body in the first position toward the second position.
